(19) United States
(12) Patent Application Publication
(10) Pub. No.: US 2004/0104948 A1
(43) Pub. Date: Jun. 3, 2004

(54) Method for controlling devices

(76) Inventors: Paul Schockmel, Mamer (LU); Guido Becker, Losheim (DE)

Correspondence Address: McCormick Paulding & Huber, CityPlace II, 185 Asylum Street, Hartford, CT, 06103-3402, US

(21) Appl. No.: 10/415,538

(22) PCT Filed: Nov. 8, 2001
(86) PCT No.: PCT/EP01/12936

(51) Int. Cl. G09G 5/00

(52) U.S. Cl. 345/863; 345/965

(57) ABSTRACT

A method for controlling appliances, machines and/or vehicles comprises the steps of

projecting a virtual control element assigned to a certain function into the action range of an operator;

contactless detection of a movement of the operator to the direction of the virtual control element; and

switching the function assigned to the virtual control element, after the operator's movement has been detected to be a switching intention.

The present invention relates to a method for controlling appliances, machines and/or vehicles or applications in vehicles, respectively.

The increasing variety of functions of modern appliances, machines or vehicles requires increasingly complex control panels in order to operate the plurality of functions combined in the appliance. The problem in designing such control panels are the often contradictory demands, on the one hand on the ergonomics of the control surfaces and, on the other hand, on the required space and the design parameters, respectively.

In order to satisfy the demand for a small space requirement, one often assigns a plurality of selectable functions to the individual control elements of the control panels. This assists in reducing the number of control elements required for operating a certain number of functions, so that the space requirement of the control panel can be reduced to a minimum. However, such a design of the control panel deteriorates the ease of operation of the appliance or the machine, respectively, as before the execution of a desired function the same has to be first selected from the plurality of functions assigned to the individual control element before the actual control of the function becomes possible. Moreover, such a control panel is absolutely unsuitable for controlling functions of machines or appliances where safety is important and where in general a fast response time of the operators is critical.

### OBJECT OF THE INVENTION

Consequently, it is an object of the present invention to propose a method for controlling appliances, machines and/or vehicles which enables a comfortable control of at least individual functions.

### GENERAL DESCRIPTION OF THE INVENTION

According to the invention, this object is achieved by a method for controlling appliances, machines and/or vehicles comprising the steps of

projecting a virtual control element assigned to a certain function into the action range of an operator;

contactless detection of an operator's movement to the direction of the virtual control element; and

switching the function assigned to the virtual control element after the operator's movement has been detected to be a switching or operation intention.

With such a method for controlling appliances, a plurality of functions of the appliance or the machine or the vehicle, respectively, can be controlled without any physical command buttons or control units having to be provided. Accordingly, the actually required physical control panels can be reduced to a minimum, so that the parameters with respect to a reduced space requirement can be satisfied more easily.

The projected virtual control elements can be projected into the operator's action range at an arbitrary location, which is easily accessed by the operator. In this manner, these virtual control elements can be arranged in an ergonomically advantageous manner and are therefore comfortable and can be reached easily, if necessary.

If the operator wants to switch the function assigned to the virtual control element, it is, for example, sufficient, to move the arm in the direction of the control element. As soon as the movement of the arm is detected to be a switch intention, e.g. when the movement has reached a sufficiently large amplitude or when it enters a certain minimum distance range of the virtual control element, the function is switched by a processor.

It should be noted that the virtual control elements can comprise e.g. simple command buttons and/or sliding control units. Depending on the type of the control element, only those criteria have to be adapted according to which a movement performed by the operator is judged to be an operation intention or a switching intention, respectively.

The virtual control element can, for example, be projected onto a given background, such as a screen. In a particularly advantageous embodiment, the projection of the virtual control element is effected holographically in the room. This embodiment is characterized by a particularly high flexibility with respect to the arrangement of the virtual control elements. Indeed, with this embodiment, the region where the virtual control elements are projected can be correspondingly adapted to the present position of the operator.

In an advantageous embodiment of the invention, the projection of the virtual control element is effected depending on the situation. This means that the virtual command button for a certain function of the appliance or a machine or a vehicle, respectively, is only projected if the operation of the respective function is necessary and/or makes sense for the control of the appliance. Such an embodiment in particular makes sense for safety-relevant functions in that, when a critical situation arises, the command button is projected to a location easily accessible by the operator to initiate countermeasures.

Moreover, the projection of the virtual control element can be limited in time, if, for example, a certain function is to be available only temporarily.

The contactless detection of a movement of the operator is effected in a first embodiment capacitively by means of capacitive sensors arranged in the region of the projected control elements. By means of these capacitive sensors, an approximation e.g. of the operator's hand to a virtual command button can be detected depending on the field of application with a sufficiently high local resolution.

A better local resolution with the contactless detection of a movement of the operator can be achieved by optical systems. Such optical systems can, for example, operate in an infrared range wherein active systems with an infrared transmitter and a receiver as well as passive systems for detecting the body heat radiated by the operator can be employed.

In a particularly advantageous variant, the contactless detection, however, is effected by imaging systems in the visible range. Apart from the movement, for example, of the operator's hand, such systems also detect the background in front of which the movement is done. This makes possible a better characterisation of the movement. Moreover, by these systems, apart from the actual detection of a movement, an object can also be detected, so that a distinction can be made whether a hand of the operator moves to the virtual command button or possibly his head. This makes possible a better and more reliable detection of a switching intention of the operator.

The imaging system can, for example, comprise a CCD camera and/or a CMOS camera. With such a camera, apart from the picture information, inter alia information as to the distance of the body part taken can be detected sequentially. Accordingly, a measurement of the distance can be performed which makes possible a more detailed characterisation of the detected movement.

In an alternative, particularly advantageous embodiment, the imaging system comprises a 3D camera. With this camera, distance information are taken contemporaneously with the picture information. This results in a shorter integration time of the information, so that a faster characterisation of the detected movement with a simultaneously reduced compute power becomes possible.

It should be noted that the above-described method can be employed in very different fields. For example, with such a method, various functions for comfort and safety in a vehicle can be controlled. Alternatively, such a method can, for example, be employed for controlling machine tools or household appliances.

1. Method for controlling appliances, machines and/or vehicles, comprising the steps of
projecting a virtual control element assigned to a certain function into the action range of an operator;
contactless detection of a movement of the operator to the direction of the virtual control element, the contactless detection being effected by means of an imaging system; and
switching the function assigned to the virtual control element, after the operator's movement has been detected to be a switching intention, characterized in that the imaging system comprises a 3D camera.

2. Method according to claim 1, characterized in that the projection of the virtual control element is effected optically onto a given background.

3. Method according to claim 1, characterized in that the projection of the virtual control element is effected holographically in the space.

4. Method according to one of claims 1 to 3, characterized in that the projection of the virtual control element is effected depending on the situation.

5. Method according to one of claims 1 to 4, characterized in that the projection of the virtual control element is effected limited in time.

6. Method according to one of claims 1 to 5, characterized in that the contactless detection of a movement of the operator is effected optically.

7. Method according to claim 6, characterized in that the contactless detection is effected in the infrared range.

8. Method according to claim 6, characterized in that the contactless detection is effected in the visible range.

9. Method according to one of the preceding claims, characterized in that the virtual control element comprises a simple command button and/or a sliding control unit and/or a variable control unit.
